(19) United States
(12) Patent Application Publication
(10) Pub. No.: US 2008/0152519 A1
(43) Pub. Date: Jun. 26, 2008

(54) GAS-OIL SEPARATOR WITH AN OIL TYPE AIR COMPRESSOR

(76) Inventor: Mei-Lien Chern, Changhua (TW)

Correspondence Address: RABIN & BERDO, P.C.;Suite 500, 1101 14th Street, N.W., Washington, DC, 20005, US

(21) Appl. No.: 11/613,500

(22) Filed: Dec. 20, 2006

(51) Int. Cl. F04B 39/04; F04B 39/16; B01D 45/14

(52) U.S. Cl. 417/430; 417/423.14; 417/423.11; 55/409

(57) ABSTRACT

A gas-oil separator with an oil type air compressor includes a gas-oil separator, a gas storage tank, and an oil return valve. The gas-oil separator installs a filer cylinder, and a helical vane in a serrated disk shape disposed at the top of the filer cylinder. After the air compressor drives compressed air into the gas-oil separator, the helical vane produces a strong helical pressure for a centrifugal separation, such that oil and gas of the compressed air is separated by the filer cylinder and the separated gas is entered and stored into the gas storage tank for. After the gas storage tank reaches a predetermined pressure, the pressure switch starts to push the long pushing bolt in the oil return valve. The separated liquid oil passes through the oil return valve and returns to the air compressor, so as to achieve the effect of separating oil and gas.

### BACKGROUND OF THE INVENTION

1. Field of the Invention

The present invention relates to a gas-oil separator with an oil type air compressor, and more particularly to a gas-oil separator comprised of an oil type air compressor, a gas-oil separator, a gas storage tank, an oil return valve for achieving the effect of separating oil and gas.

2. Description of the Related Art

In general, an air compressor usually produces lots of noises and discharge lots of oils, but an oil type air compressor using lubricant oils for its operation has been developed in recent years. Since such oil type air compressor is fully closed, therefore there is no noise, but the compressed air also contains liquid oils which are not allowed to be in a gas storage tank.

### SUMMARY OF THE INVENTION

In view of the foregoing shortcomings of the prior art, the inventor of the present invention based on years of experience in the related industry to conduct extensive researches and experience, and finally developed a gas-oil separator with an oil type air compressor in accordance with the present invention.

The primary objective of the present invention is to overcome the shortcomings of the prior art by providing an oil type air compressor comprised of a gas-oil separator, a gas storage tank, and an oil return valve, and the air compressor drives the compressed air to enter into the gas-oil separator for separating liquid oil and compressed air, and the compressed air is entered and stored into the gas storage tank, and the remained liquid oil drives the oil return valve to operate by using the pressure switch, and the remained liquid oil is returned into the air compressor automatically to achieve the effect of separating oil and gas.

Another objective of the present invention is to provide a gas-oil separator with an oil type air compressor, wherein the gas-oil separator installs a filer cylinder, a helical vane substantially in a serrated disk shape disposed at the top of the filer cylinder. If the air compressor sends the high-pressure compressed air into the gas-oil separator, the helical vane at the filer cylinder will start operating to produce a helical pressure to centrifuge and separate the compressed air containing liquid oil, so that the liquid oil will be attached onto the internal wall of a cylindrical body of the gas-oil separator and the liquid oil will flow downward and be stored at the bottom of the cylindrical body. Then, the compressed air is separated for the second time by the filer cylinder, and finally the filtered compressed air exits the gas-oil separator and enters into the gas storage tank for its storage.

A further objective of the present invention is to provide a gas-oil separator with an oil type air compressor, wherein a pressure switch is connected the gas storage tank and operated by the design of the oil return valve, and the oil return valve is installed in a main body and comes with an axial hole of a different diameter, and a stopper ball and a spring are installed at the front end of the oil return valve, and a long pushing bolt and a spring are installed at the rear end of the oil return valve, and then each of both ends has a screw bolt for limiting the position and attaching the long pushing bolt onto the surface of the stopper ball. A transverse outlet is disposed at the middle position of the axial hole. After the stopper ball is pushed and moved, the inlet at a lateral side of the axial hole and the outlet at the long pushing bolt will be interconnected. After the separated compressed air enters into the gas storage tank and a predetermined pressure is reached, the pressure switch will operate to push the long pushing bolt of the oil return valve to move, such that the stopper ball is moved, and the inlet and the outlet at the long pushing bolt will be interconnected. Therefore, the separated liquid oil in the gas-oil separator will pass through the oil return valve and return into the air compressor.

### BRIEF DESCRIPTION OF THE DRAWINGS

FIG. 1 is a perspective view of the present invention;

FIG. 2A is an exploded view of a gas-oil separator of the present invention;

FIG. 2B is a cross-sectional view of a gas-oil separator of the present invention;

FIG. 3A is an exploded view of an oil return valve of the present invention;

FIG. 3B is a cross-sectional view of an oil return valve of the present invention;

FIG. 4 is a schematic view of a first preferred embodiment of the present invention; and

FIG. 5 is a schematic view of a second preferred embodiment of the present invention.

### DETAILED DESCRIPTION OF THE PREFERRED EMBODIMENTS

To make it easier for our examiner to understand the objectives, characteristics and effects of the present invention, a preferred embodiment with accompanying drawings are used for a detailed description of the invention as follows.

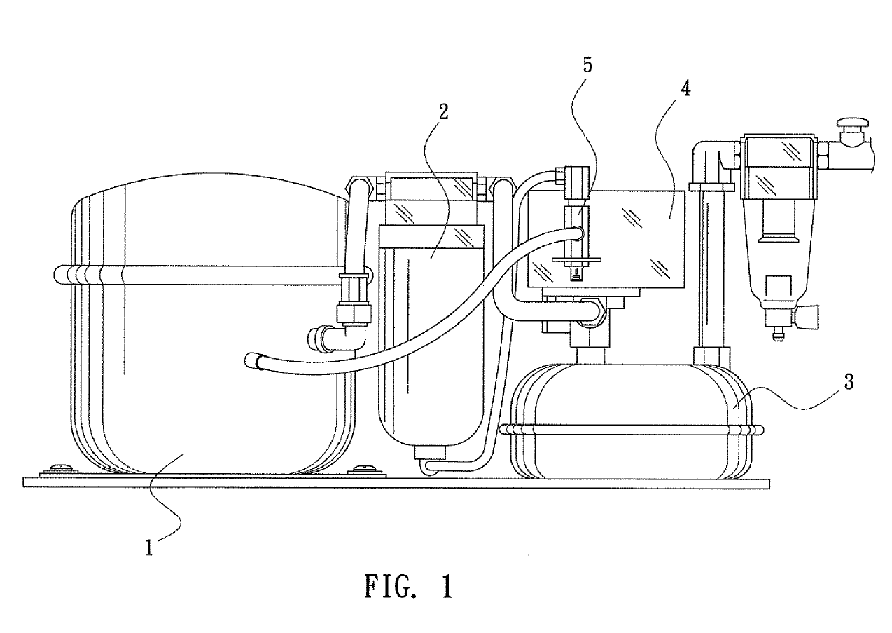

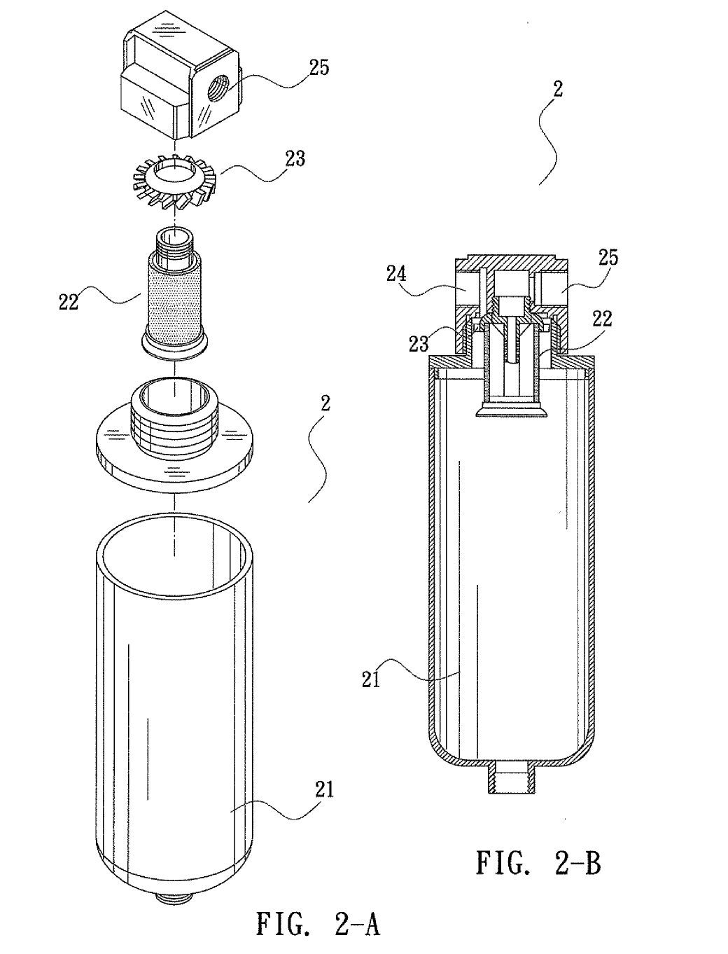

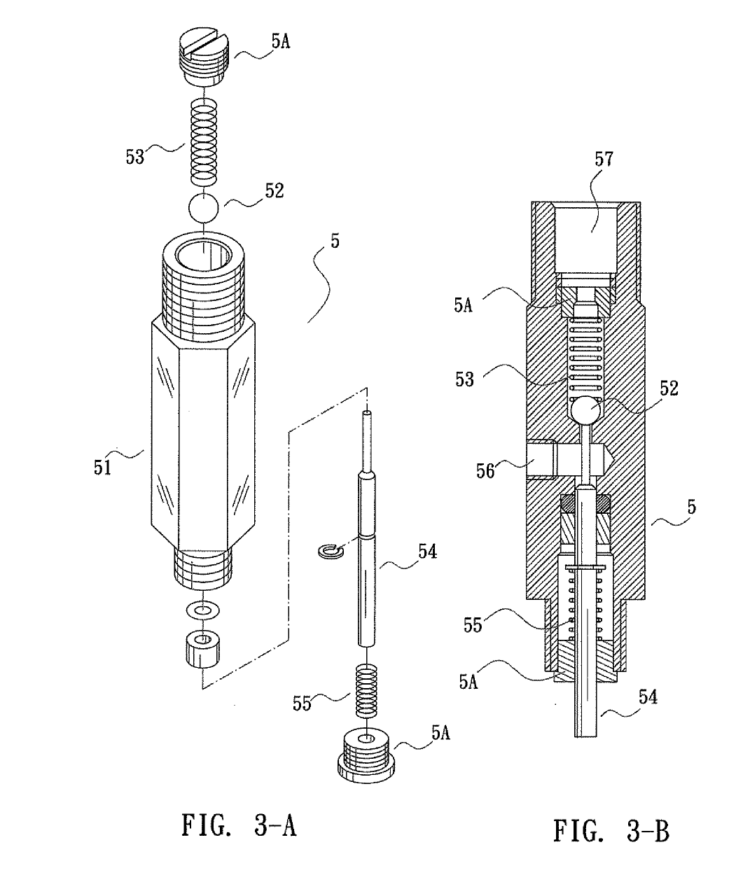

Referring to FIG. 1, a gas-oil separator with an oil type air compressor of the invention comprises an air compressor 1, a gas-oil separator 2, a gas storage tank 3, a pressure switch 4, and an oil return valve 5. The air compressor 1 primarily absorbs the outside air for the compression, and the compressed air A is entered into the gas-oil separator 2 which is comprised of a cylindrical body 21 disposed outside and a filer cylinder 22 disposed inside, a helical vane 23 slightly in a serrated disk shape and disposed at the top of the filer cylinder 22 (as shown in FIGS. 2A and 2B) and an inlet 24 and an air outlet 25 disposed at the top of the gas-oil separator 2, such that after the compressed air A enters into the air inlet 24 of the gas-oil separator 2, the compressed air is moved towards the cylindrical body 21, and then passed through the filer cylinder 22 for the filtering and finally discharged from the air outlet 25 into the gas storage tank 3. The gas storage tank 3 is connected to the pressure switch 4 for controlling the oil return valve 5, and the oil return valve 5 is installed in the main body 51 and comes with a different axial diameter, and a stopper ball 52 and a spring 53 are disposed at the front end, and a long pushing bolt 54 and a spring 55 are disposed at the rear end, and each of both ends has a screw bolt 5A for limiting the position, such that the long pushing bolt 54 can be attached onto the surface of the stopper ball 52, and a transverse outlet 56 is disposed at the middle of the axial hole (as shown in FIGS. 3A and 3B). After the stopper ball 52 is pushed, the inlet 57 at a lateral side of the axial hole and the outlet 56 at the long pushing bolt 54 are interconnected.

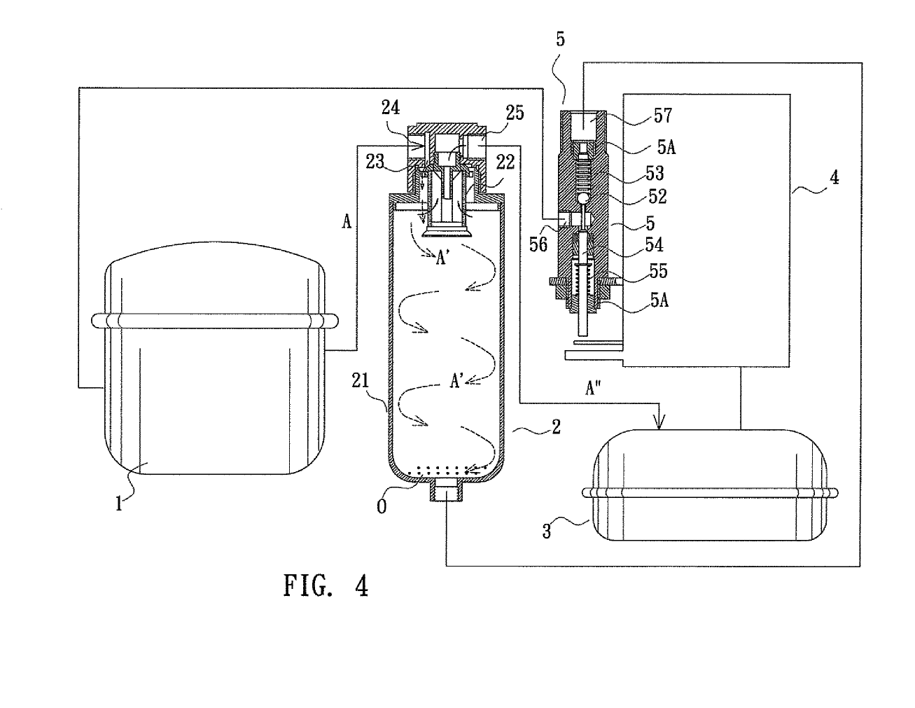

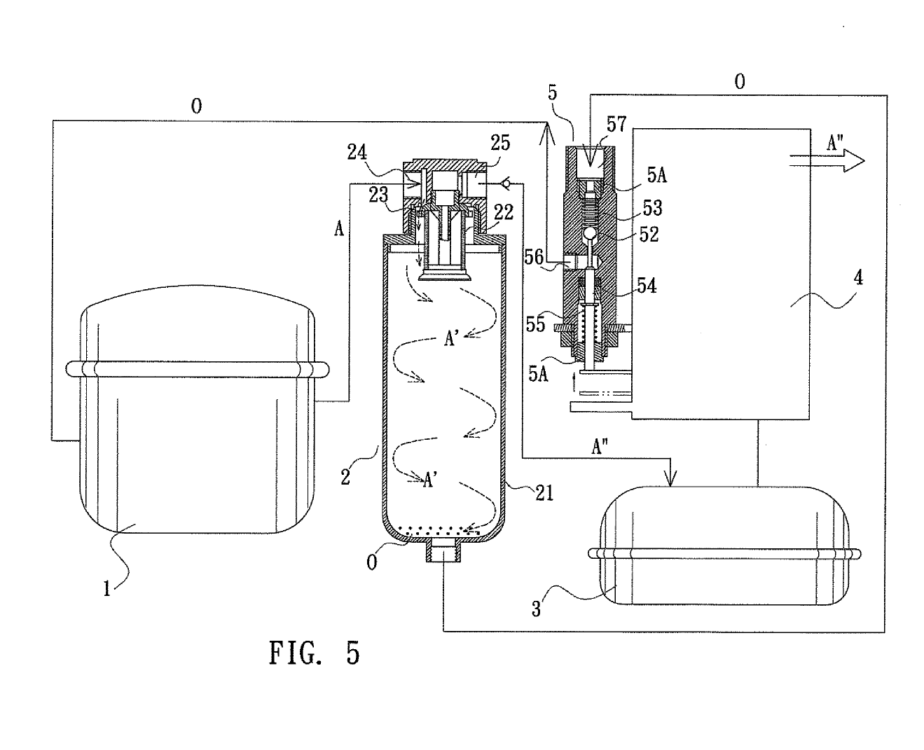

If the air compressor 1 sends the compressed air A into the air inlet 24 of the gas-oil separator 2 and the compressed air moves towards the cylindrical body 21, the helical vane 23 of the filer cylinder 22 starts operating to produce a strong helical pressure, so that the compressed air A containing the liquid oil O is centrifuged for separating the air and the oil, and the liquid oil O will be attached onto the internal wall of the cylindrical body 21 of the gas-oil separator 2 and the liquid oil flows downward and is stored at the bottom of the cylindrical body. While the compressed air A′ is entering into the filer cylinder 22, the filtering process of the filer cylinder 22 performs a second separation. The filtered compressed air A″ passes through the air outlet 25 and exits the gas-oil separator 2, and the compressed air A′ is entered into the gas storage tank 3 for its storage (as shown in FIG. 4). After the compressed air A″ enters into the gas storage tank 3 and reaches a predetermined pressure, the pressure switch 4 starts operating to push the long pushing bolt 54 of the oil return valve 5 to move and drive the stopper ball 52 away. The inlet 57 originally sealed by the stopper ball 52 is interconnected with the outlet 56 (as shown in FIG. 5). Therefore, the liquid oil O separated by the gas-oil separator 2 flows through the oil return valve 5 and returns into the air compressor 1 automatically. If the pressure switch 4 ascends, the pressure switch 4 will return to its original state again, and the oil return valve 5 is closed again (as shown in FIG. 4). After the compressed air A′ in the gas storage tank 3 is saturated, the predetermined pressure is used for resuming the operation of the pressure switch 4 and the oil return valve 5.

In summation of the description above, the present invention herein enhances the performance over the conventional structure, and definitely can overcome the shortcomings of the prior art and comply with the requirements of patent application, and is thus duly filed for patent application.

What is claimed is:

1. A gas-oil separator with an oil type air compressor, comprising an oil type air compressor, a gas-oil separator, a gas storage tank, and an oil return valve, such that after said air compressor enters compressed air into said gas-oil separator, liquid oil and compressed air are separated, and said compressed air is entered and stored in said gas storage tank, and the remained liquid oil is driven by a predetermined pressure of a pressure switch to drive said oil return valve to operate, and returned into said air compressor automatically, so as to achieve the effect of separating oil and gas.

2. The gas-oil separator with an oil type air compressor of claim 1, wherein said gas-oil separator comprises a cylindrical body disposed outside of said gas-oil separator, a filer cylinder, a helical vane substantially in a serrated disk shape and disposed at the top of said filer cylinder, and an air inlet and an air outlet disposed at the top of said gas-oil separator such that after said air compressor absorb outside air for a compression, said compressed air is sent into said gas-oil separator, and said helical vane on said filer cylinder starts operating to produce a strong helical pressure and a centrifugal separation for said compressed air containing a liquid oil, and said liquid oil is attached onto an internal wall of said gas-oil separator and then flows downward to be stored at the bottom of said cylindrical body, and then said compressed air is entered into said filer cylinder, and said compressed air is filtered again by said filer cylinder, and discharged from said gas-oil separator through said air outlet and stored in said gas storage tank.

3. The gas-oil separator with an oil type air compressor of claim 1, wherein said pressure switch connected to said gas storage tank is designed based on the operation of said oil return valve, such that said oil return valve is installed in a main body and comes with a different axial hole, a stopper ball and a spring installed at a front end, a long pushing bolt and a spring installed at a rear end, a screw bolt disposed on each of both ends for limiting a position, such that said long pushing bolt can be attached onto the surface of said stopper ball, and a transverse outlet disposed at the middle of said axial hole, and a predetermined pressure of said pressure switch pushes said long pushing bolt of said oil return valve moves said stopper ball downward, and said inlet and said outlet are interconnected, and said separated liquid oil is passed through said oil return valve and returned automatically into said air compressor.
